(19) United States
(12) Patent Application Publication
(10) Pub. No.: US 2024/0284900 A1
(43) Pub. Date: Aug. 29, 2024

(54) Line Depth Adjusters and Methods of Use

(71) Applicant: Keith Krohe, Table Grove, IL (US)

(72) Inventor: Keith Krohe, Table Grove, IL (US)

(21) Appl. No.: 18/589,925

(22) Filed: Feb. 28, 2024

Related U.S. Application Data
(60) Provisional application No. 63/487,333, filed on Feb. 28, 2023.

(51) Int. Cl. A01M 31/06

(52) U.S. Cl. CPC A01M 31/06

(57) ABSTRACT

In some embodiments, the decoy line adjuster can include a line and a body having: a top end; a bottom end; a fin a first flange; and/or a second flange. In some embodiments, the body is divided into a decoy attaching potion; a spool potion; and an anchoring potion. In some embodiments, the decoy attaching potion can include an aperture. In some embodiments, the anchoring attaching portion can include a body notch configured to receive the line. In some embodiments, the anchoring attaching potion can include a line locking system. In some embodiments, the second flange includes a flange notch configured to receive the line.

### CROSS-REFERENCE TO RELATED APPLICATIONS

This application claims priority benefits from U.S. provisional application No. 63/487,333 filed on Feb. 28, 2023, entitled “Line Depth Adjusters and Methods of Use”. The '333 application is hereby incorporated by reference herein in its entirety.

### FIELD OF THE INVENTION

This invention relates to a line depth adjuster that can be used with a floating decoy. In some embodiments, the invention relates to devices, systems, and methods for adjusting the length of a line associated with a waterfowl decoy. In some embodiments, the present disclosure is directed to a decoy line depth adjusting spool. In some embodiments, the present disclosure is directed to a decoy line depth adjusting reel.

Often waterfowl hunters attract waterfowl by setting waterfowl decoys in bodies of water such as lakes and ponds. Often multiple decoys are used at once to create a realistic scene to attract live waterfowl. Each decoy is typically attached to a weight/anchor with a line/cord to prevent the decoys from floating too far away from where the hunter has positioned them.

While hunting, water levels often rise or fall, which can cause displacement of the waterfowl decoys. For instance, if the water level rises, the line/cord may become too taught, causing the decoy to bob or dip into the water unrealistically. In another instance, if the water level drops, the line/cord can have excess slack, causing the decoy to float away from its anchored position and/or become twisted with another decoy. In either instance, the hunter has to adjust the decoy by cutting and/or retying the decoy to the anchor. Therefore, there exists a need for a device that can aid in adjusting the length of the line/cord for decoys.

### SUMMARY OF THE INVENTION

A decoy line adjuster can include a line; and a body. In some embodiments, the body can include a top end; a bottom end; a fin; a first flange; and/or a second flange. In some embodiments, the body is divided into a decoy attaching potion; a spool potion; and an anchoring potion. In some embodiments, decoy attaching potion comprises an aperture.

In some embodiments, the anchoring attaching potion comprises a body notch configured to receive said line; and/or a line locking system. In some embodiments, the line locking system includes a first hook, a second hook, a guide wall, and/or a guide rod.

In some embodiments, the second flange includes a flange notch configured to receive a line. In some embodiments, the fin protrudes perpendicularly from the body. In some embodiments, the fin extends longitudinally from said top end to said bottom end along the length of said body. In some embodiments, the first flange is parallel to the second flange.

In some embodiments, the first flange is perpendicular to the fin. In some embodiments, the first hook and the second hook have generally opposite orientations.

In some embodiments, the decoy line adjuster can include a line; a spool; and/or a shell comprising: an oval base; a wall extending up from said oval base; an axle; and/or a tab with an aperture. In some embodiments, the axle is configured to support said spool. In some embodiments, the spool has a plurality of teeth configured to interact with a plurality of cleats located on said wall. In some embodiments, the shell includes a tab.

Methods for using a decoy line adjuster are disclosed.

In some embodiments, a system includes a decoy line adjuster; a decoy; a weight; and a line.

### BRIEF DESCRIPTION OF THE DRAWINGS

FIG. 1 is a front plan view of an embodiment of a line depth adjuster.

FIG. 2 is a left side plan view of the line depth adjuster of FIG. 1.

FIG. 3 is a back plan view of the line depth adjuster of FIG. 1.

FIG. 4 is a bottom plan view of the line depth adjuster of FIG. 1.

FIG. 5 is a front perspective view of the line depth adjuster of FIG. 1.

FIG. 6 is a back perspective view of the line depth adjuster of FIG. 1.

FIG. 7 is a front perspective view of the line depth adjuster of FIG. 1 with a line.

FIG. 8 is a front plan view of another embodiment of a line depth adjuster.

FIG. 9 is a left side plan view of the line depth adjuster of FIG. 8.

FIG. 10 is a back plan view of the line depth adjuster of FIG. 8.

FIG. 11 is a bottom plan view of the line depth adjuster of FIG. 8.

FIG. 12 is a front perspective view of the line depth adjuster of FIG. 8.

FIG. 13 is a top perspective view of the front of the embodiment of the line depth adjuster of FIG. 8.

FIG. 14 is a top perspective view of the side of the embodiment of the line depth adjuster of FIG. 8.

FIG. 15 is a top perspective view of the back of the line depth adjuster of FIG. 8.

FIG. 16 is a front plan view of the line depth adjuster of FIG. 8 with a line.

FIG. 17 is a right-side plan view of the line depth adjuster of FIG. 8 with a line.

FIG. 18 is a back plan view of the line depth adjuster of FIG. 8 with a line.

FIG. 19 is a left-side plan view of the line depth adjuster of FIG. 8 with a line.

FIG. 20 is a bottom plan view of the line depth adjuster of FIG. 8 with a line.

FIG. 21 is a front perspective view of the line depth adjuster of FIG. 8 with a line.

FIG. 22 is a back perspective view of the embodiment of the line depth adjuster of FIG. 8 with a line.

FIG. 23 is a front view of another embodiment of a line depth adjuster.

FIG. 24 is a back view of a line depth adjuster of FIG. 23.

FIG. 25 is a bottom view of a line depth adjuster of FIG. 23.

FIG. 26 is a top view of a line depth adjuster of FIG. 23.

FIG. 27 is a side cutaway view of a line depth adjuster of FIG. 23.

FIG. 28 is a front perspective view of the line depth adjuster of FIG. 23.

FIG. 29 is an exploded front view of the line depth adjuster of FIG. 23.

FIG. 30 is an exploded back view of the embodiment of the line depth adjuster of FIG. 23.

FIG. 31 is a schematic drawing of a line depth adjuster being utilized with a decoy and a weighted anchor.

FIG. 32 is a schematic drawing of another embodiment of a line depth adjuster being utilized with a weighted anchor.

FIG. 33 is a right-side perspective view of a portion of the line depth adjuster of FIG. 32 with a line.

FIG. 34 is a left side perspective view of a portion of the embodiment of the line depth adjuster of FIG. 32 with a line.

### DETAILED DESCRIPTION OF ILLUSTRATIVE EMBODIMENT(S)

A more detailed description of the device, systems, and methods in accordance with the present disclosure is set forth below. It should be understood that the description below of specific devices, systems, and methods is intended to be exemplary, and not exhaustive of all possible variations or applications. Thus, the scope of the disclosure is not intended to be limiting and should be understood to encompass other variations or embodiments.

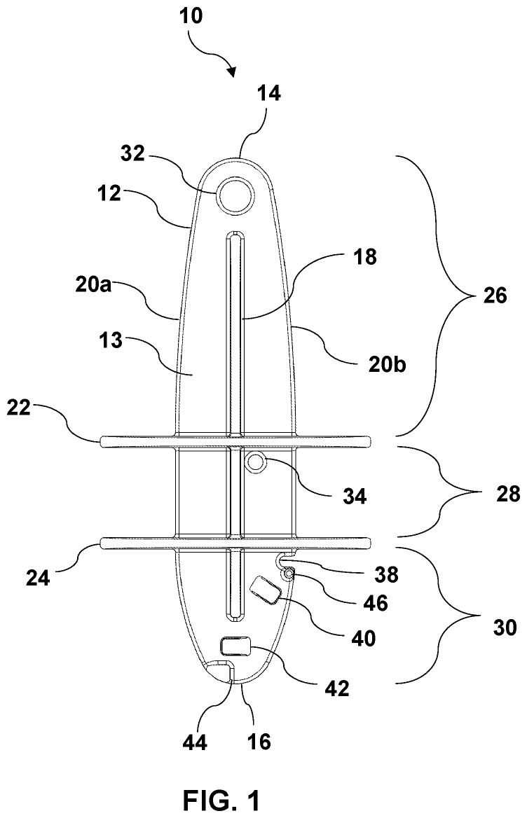

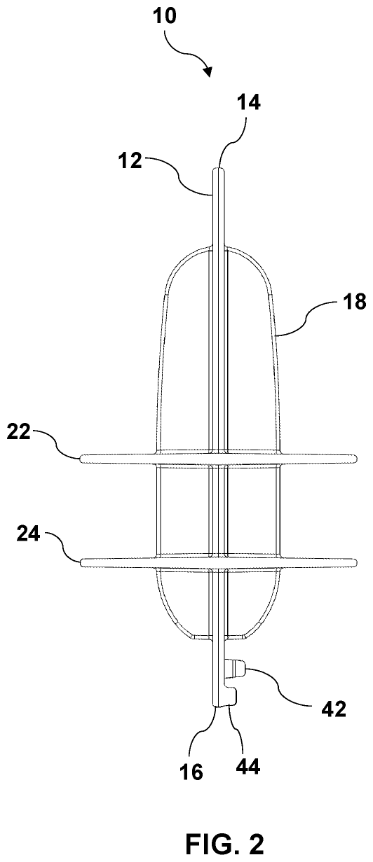

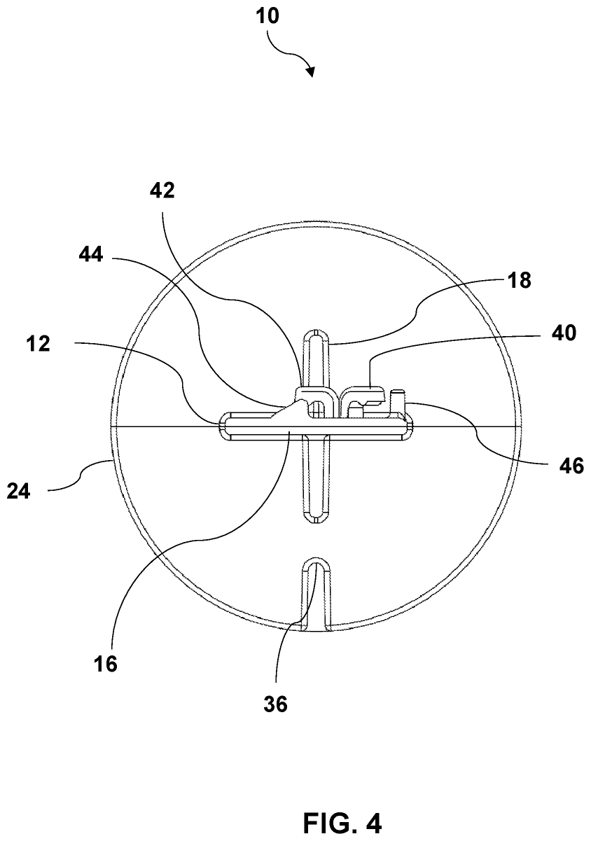

FIGS. 1-7 illustrate embodiments of decoy line adjuster 10. In some embodiments, decoy line adjuster 10 can be used to connect a floating hunting decoy to an anchor. For instance, in some embodiments, decoy line adjuster 10 can be used to connect a waterfowl decoy to an anchor. In some embodiments, the decoy line adjuster 10 can adjust the length of line/cord 50 between decoy line adjuster 10 and the anchor. In some embodiments, decoy line adjuster 10 can be an adjusting spool. In some embodiments, line 50 can be a cord and the terms can be used interchangeably.

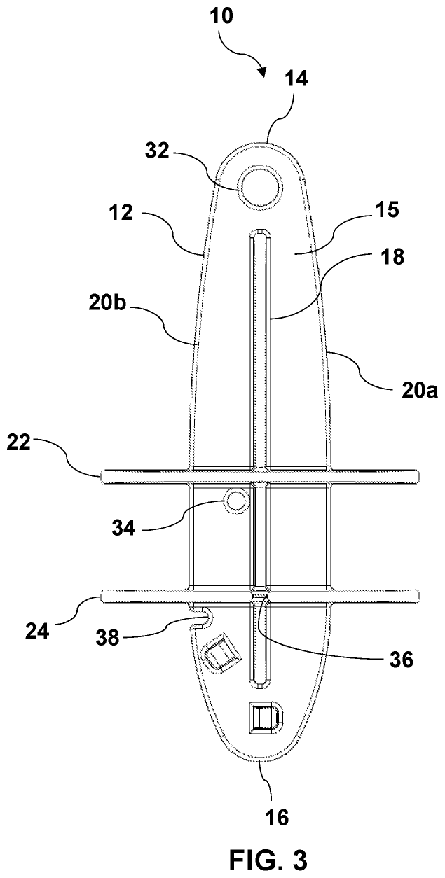

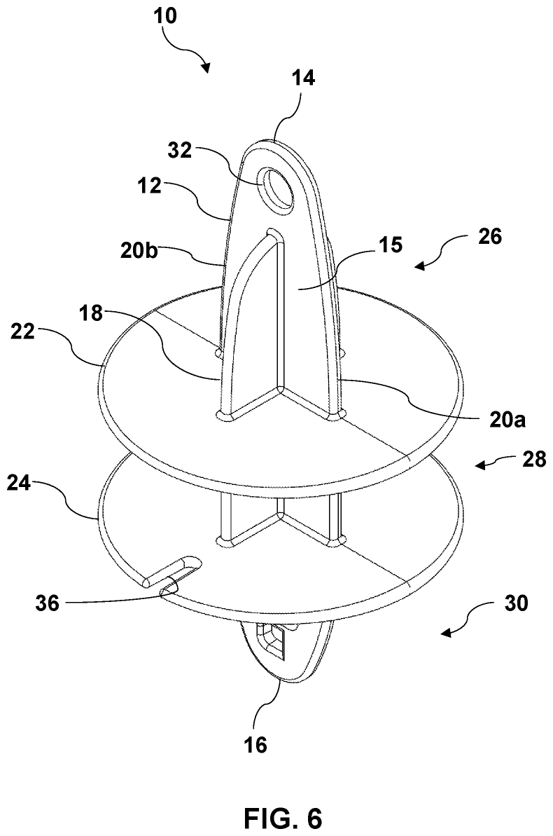

As shown in FIGS. 1-7, in some embodiments decoy line adjuster 10 can have body 12. Body 12 can include top end 14 and bottom end 16. In some embodiments, body 12 can also include opposed first face 13 and second face 15 (shown in FIGS. 3 and 6). In some embodiments, body 12 can be oblong. For example, in some embodiments, body 12 can have a generally oval shape. In some embodiments, body 12 can have a generally rectangular shape. The shape of body 12 can vary without departing from the scope of the disclosure.

In some embodiments, body 12 includes fin 18. In some embodiments, fin 18 protrudes perpendicularly from body 12. For example, in some embodiments, fin 18 protrudes perpendicularly from first face 13 and/or second face 15 of body 12. In some embodiments, fin 18 can be oblong. For example, in some embodiments, fin 18 can have a generally oval shape. In some embodiments, fin 18 can have a generally rectangular shape. The shape of fin 18 can vary without departing from the scope of the disclosure.

In some embodiments, fin 18 extends longitudinally, in a direction from top end 14 to bottom end 16 of body 12. For example, in some embodiments, fin 18 extends the length of body 12. In some embodiments, fin 18 partially extends the length of body 12. In some embodiments, fin 18 is shorter than the length of body 12. Furthermore, in some embodiments, fin 18 extends longitudinally through the center of body 12, dividing the body into first longitudinal half 20a and second longitudinal half 20b.

In some embodiments, body 12 includes at least one flange. In some embodiments, body 12 includes two flanges. In some embodiments, body 12 includes three flanges. In some embodiments, body 12 includes four flanges.

In some embodiments, body 12 includes first flange 22 and second flange 24. In some embodiments, first flange 22 and second flange 24 are parallel and spaced apart from one another. In some embodiments, first flange 22 and/or second flange 24 have a larger circumference than the circumference defined by body 12 and/or fin 18. In other words, in some embodiments, first flange 22 and/or second flange 24 extend beyond body 12 and fin 18. In some embodiments, first flange 22 and/or second flange 24 are perpendicular to body 12 and/or fin 18.

In some embodiments, fin 18, first flange 22, and/or second flange 24 can be attached to body 12. For example, fin 18, first flange 22, and/or second flange 24 can be attached via adhesion, welding, or other attachment methods. In some embodiments, body 12, fin 18, first flange 22, and/or second flange 24 can be manufactured as a singular, unitary piece. In some embodiments, first flange 22 and/or second flange 24 can be replaceable and/or can be swapped with other flanges with alternative properties, such as larger or smaller diameters.

In some embodiments, decoy line adjuster 10 can include decoy attaching portion 26, spool portion 28, and/or anchor attaching portion 30. For example, in some embodiments, decoy attaching portion 26 can include the portion extending from top end 14 to first flange 22. In some embodiments, spool portion 28 can include the portion extending from first flange 22 to second flange 24. In some embodiments, anchor attaching portion 30 can include the portion extending from second flange 24 to bottom end 16.

Turning to decoy attaching portion 26, decoy attaching portion 26 extends from top end 14 to first flange 22. In some embodiments, decoy attaching portion 26 can include aperture 32. In some embodiments, aperture 32 can be used to attach a decoy to the decoy line adjuster 10. For example, in some embodiments, decoy line adjuster 10 can be directly attached to a decoy via aperture 32. In some embodiments, one end of a line can be tied or otherwise attached to aperture 32 and the other end of the line can be tied or otherwise attached to a decoy.

In some embodiments, aperture 32 can be located on body 12. For example, in some embodiments, aperture 32 can be located near the top end 14. In this instance, fin 18 can be located below aperture 32 and extends towards the bottom end 16. In some embodiments, aperture 32 can be located on fin 18. The location of aperture 32 in decoy attaching portion 26 can vary without departing from the scope of the disclosure.

In some embodiments, spool portion 28 extends from first flange 22 to second flange 24. In some embodiments, spool portion 28 can be configured to resemble a spool and can be used to attach line 50 to decoy line adjuster 10 and/or to store excess line 50. In some embodiments, first flange 22 and second flange 24 can be spaced from one another, defining the ends of the spool. In at least some embodiments, the area between first flange 22 and second flange 24, including body 12 and fin 18, act as a barrel of a spool.

To attach line 50 to decoy line adjuster 10, in some embodiments, spool portion 28 can include spool aperture 34. For example, one end of line 50 can be tied or otherwise attached to the spool aperture 34. After line 50 is attached, a user can wrap line 50 around body 12 and fin 18 of spool portion 28 until a desired length of remaining line 50 is attained.

In some embodiments, spool aperture 34 can be located on body 12. For example, spool aperture 34 can be located in second longitudinal half 20b of body 12 near the intersection of fin 18 and first flange 22. In some embodiments, spool aperture 34 can be located on fin 18. The location of spool aperture 34 in the spool portion 28 can vary without departing from the scope of the disclosure.

In some embodiments, second flange 24 can include flange notch 36 in its perimeter, as shown in FIGS. 3-4 and 6. In some embodiments, flange notch 36 extends towards second face 15 of body 12. For example, in some embodiments, flange notch 36 extends towards fin 18. In some embodiments, flange notch 36 is deep enough to receive line 50. For example, in some embodiments after attaching line 50 to spool portion 28 and the desired length of remaining line 50 is attained, line 50 can be passed through flange notch 36 and under second flange 24 to bring line 50 to anchor attaching portion 30.

In some embodiments, anchor attaching portion 30 extends from second flange 24 to bottom end 16. In some embodiments, the perimeter of anchor attaching portion 30 can include body notch 38 for receiving line 50 from spool portion 28. For example, in some embodiments, body notch 38 can be located near the top of anchor attaching portion 30, under second flange 24.

Additionally, in some embodiments, anchor attaching portion 30 includes a line locking system. In some embodiments, the locking system can be located on first face 13 of body 12. In some embodiments, the locking system includes at least one hook extending from body 12. In some embodiments, the locking system includes two hooks. In some embodiments, the locking system includes three hooks. In some embodiments, the locking system includes four hooks.

In some embodiments, the locking system includes first hook 40 and second hook 42. In some embodiments, first hook 40 and second hook 42 can generally be “J” shaped.

In some embodiments, first hook 40 and second hook 42 can have a first portion extending from body 12 that is substantially perpendicular with the plane of first face 13. Additionally, in at least some embodiments, first hook 40 and second hook 42 can have a second portion extending from the first portion, the second portion being substantially perpendicular with the first portion and parallel with the plane of first face 13.

In some embodiments, first hook 40 is located in the second longitudinal half 20b of body 12, below body notch 38. In some embodiments, the second portion of first hook 40 generally extends in a direction away from the first longitudinal half 20a of body 12. For example, in some embodiments, first hook 40 can be angled towards bottom end 16 of the body and away from first longitudinal half 20a.

In some embodiments, second hook 42 is located below fin 18 and in a staggered position relative to first hook 40. In some embodiments, the second portion of second hook 42 can extend towards first longitudinal half 20a of body 12. In at least some embodiments, the staggered locations and generally opposite orientations of hooks 40 and 42 allow for adjustable line 50 to be held in place by frictional forces. For example, after line 50 is run through body notch 38, first hook 40, and second hook 42, frictional forces between line 50 and body notch 38, line 50 and first hook 40, and/or line 50 and second hook 42 can keep line 50 in place.

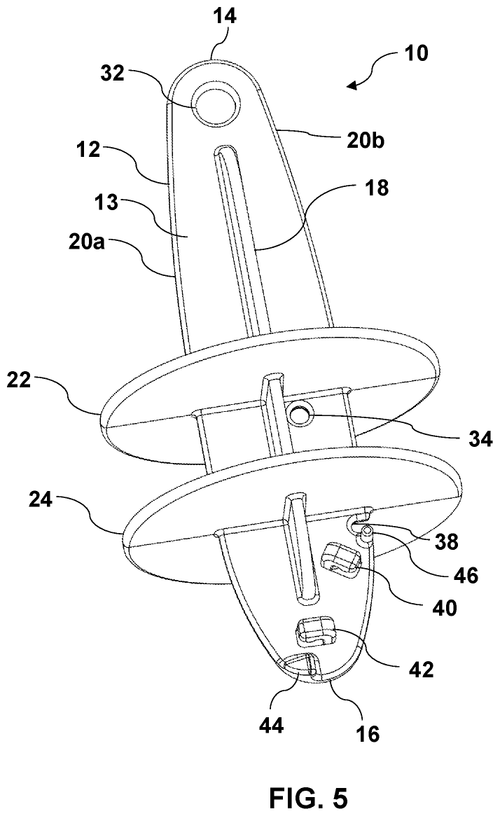

In some embodiments, line 50 can be further secured by guiding elements. For example, in some embodiments, locking system can also include a guide wall 44. Guide wall 44 can extend perpendicularly from first face 13 of body 12. In some embodiments, guide wall 44 can be located at bottom end 16 of body 12, below second hook 42. In some embodiments, guide wall 44 can extend longitudinally towards top end 14 of body 12. In some embodiments, guide wall 44 can keep adjustable line 50 from unhooking itself from second hook 42, can strengthen the frictional force between line 50 and second hook 42, and/or can add additional surface area on which a frictional force can act to keep line 50 in place. In some embodiments, the locking system can include guide rod 46 (as shown in FIG. 5). Similar to guide wall 44, guide rod 46 can keep adjustable line 50 from unhooking itself from first hook 40, can strengthen the frictional force between line 50 and first hook 40, and/or can add additional surface area on which a frictional force can act to keep adjustable line 50 in place. In some embodiments, guide rod 46 can be located directly below body notch 38.

In some embodiments, the distance between the second portion of the hooks and body 12 can be smaller than the diameter of adjustable line 50. In some embodiments, the distance between the second portion of the hooks and body 12 can be slightly larger than the diameter of adjustable line 50. In some of these embodiments, after adjustable line 50 has been passed through the locking system, line 50 can be further secured by a squeezing force between the second portion of the hook and body 12. In some embodiments, the locking system can include apertures underneath the second portion of the hooks. In this instance, line 50 can be further secured by crimping caused by forces acting on line 50 from the hook and edges of the aperture. In some embodiments, the hooks can be made of a flexible material. In some of these embodiments, after passing line 50 through the locking system, the hooks can be crimped around line 50 to hold line 50 in place. In some embodiments, the locking system can include one or a combination of the features described herein.

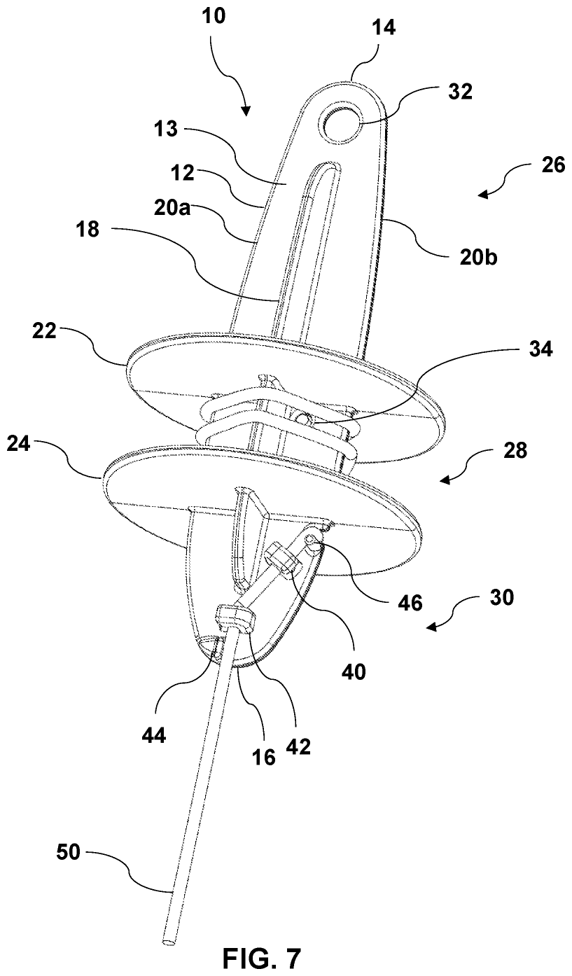

As shown in FIG. 7, to use some embodiments of decoy line adjuster 10, adjustable line 50 can be attached to decoy line adjuster 10 via spool aperture 34. For example, in some embodiments, a user can pass line 50 through the spool aperture 34 to tie line 50 to decoy line adjuster 10. In some embodiments, line 50 can be passed through spool aperture 34 and a knot can then be tied in the portion of line 50 that passed through spool aperture 34, thus preventing, or at least reducing the chance that line 50 falls back through spool aperture 34. After attaching line 50 to decoy line adjuster 10, line 50 can be wrapped around spool portion 28 until a desired length of line 50 remains to be attached to an anchor. The remaining line 50 can be passed through flange notch 36, then under second flange 24, and through body notch 38. Adjustable line 50 can then be hooked through the locking system by passing the line through first hook 40 and second hook 42. The end of line 50 can be attached to an anchor.

In some embodiments, to adjust the length of adjustable line 50, the user could unhook line 50 from second hook 42 and first hook 40, and then remove line 50 from body notch 38 and flange notch 36. If the user desires to shorten the length of line 50, the user can wrap the excess line 50 around spool portion 28 until the desired amount of line 50 remains. The user can then pass line 50 through the locking system as described above to secure line 50 in place. If the user desires to lengthen line 50, after removing line 50 from the locking system and notches 36 and 38, the user can unravel a desired length of line 50 from spool portion 28 until the desired length of line 50 is attained, and then pass line 50 through the locking system.

In some embodiments, at least some of the parts, if not all of the decoy line adjuster 10 can be made of a noncorrosive material, such as, but not limited to, one or more types of plastic. In some embodiments, decoy line adjuster 10 can be made of nylon.

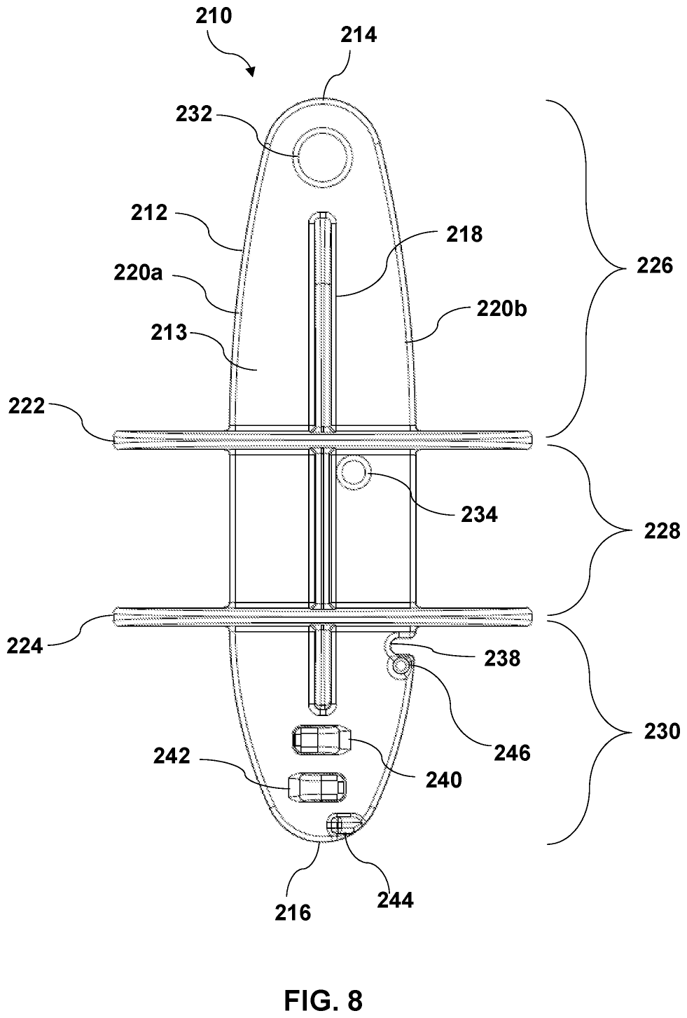

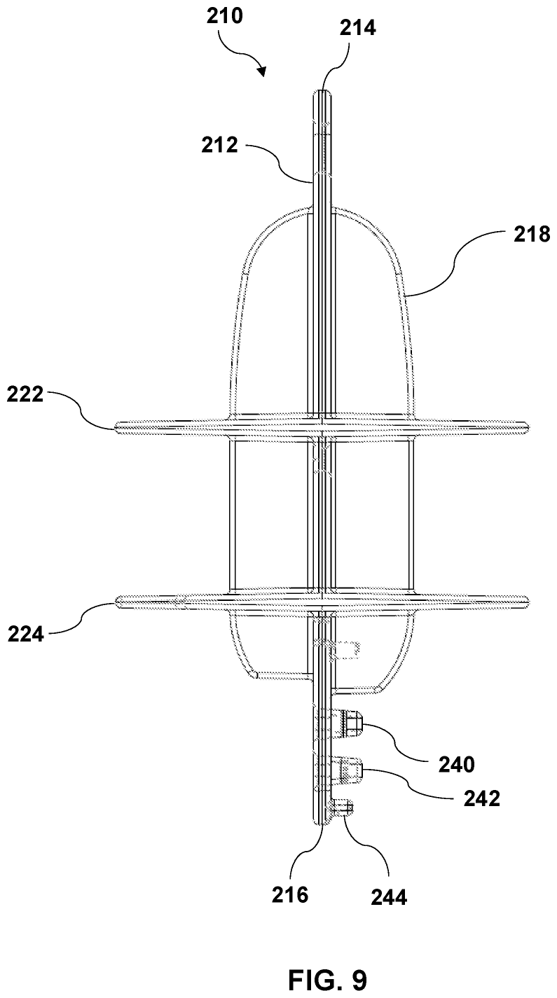

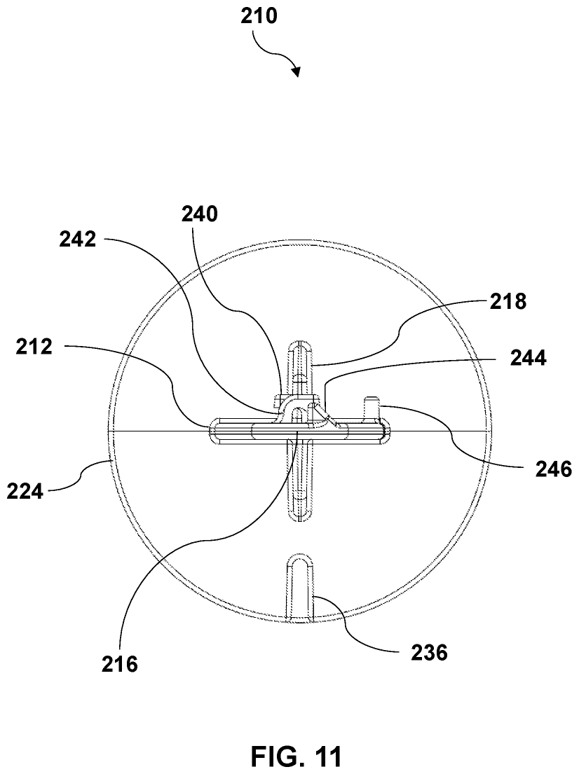

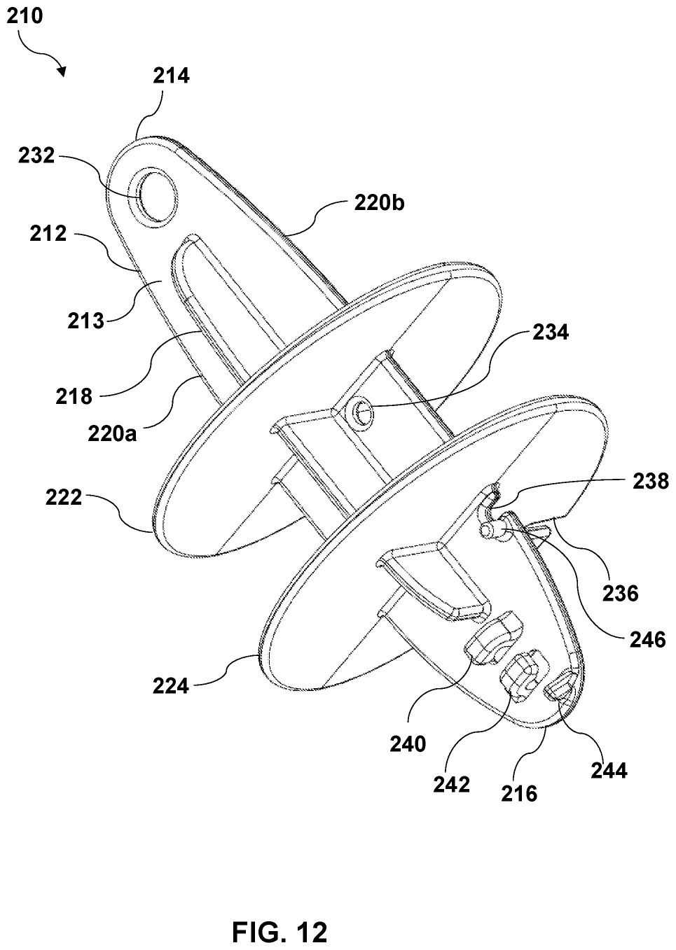

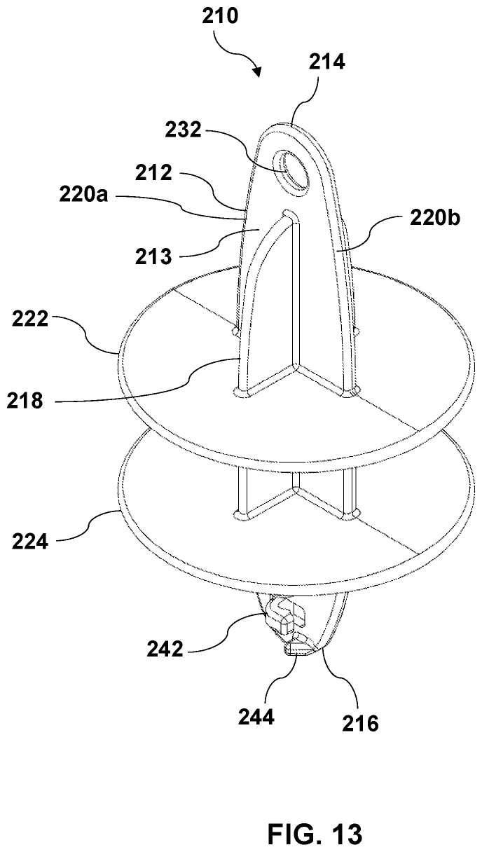

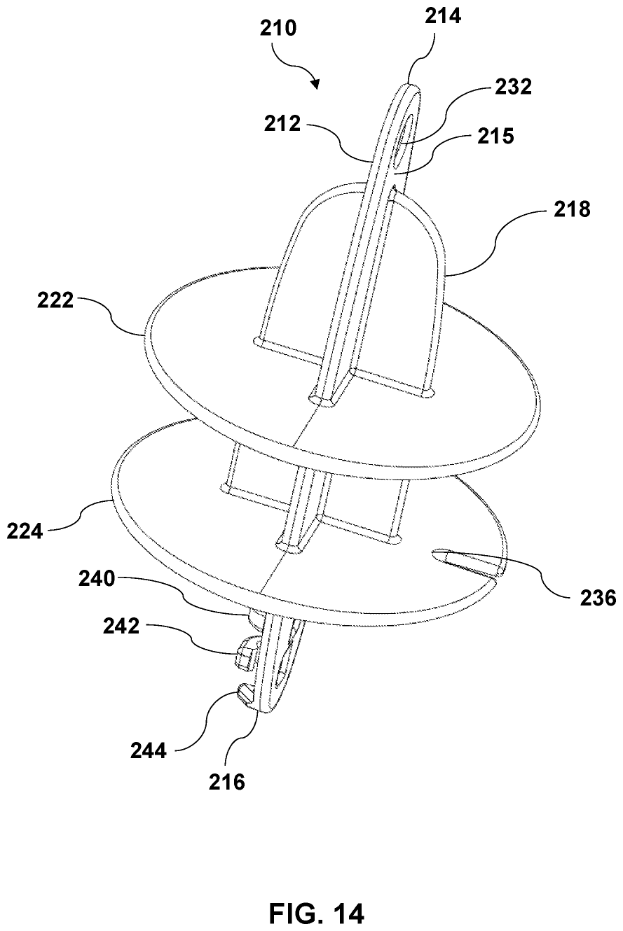

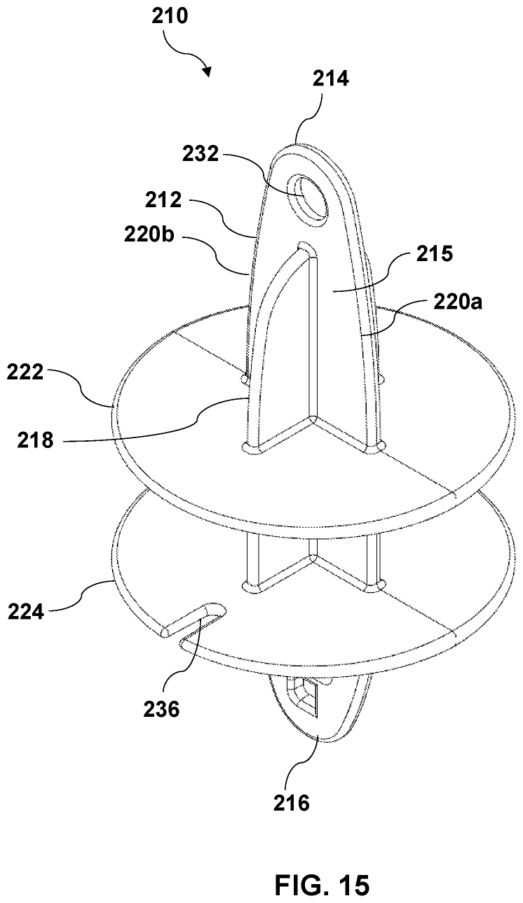

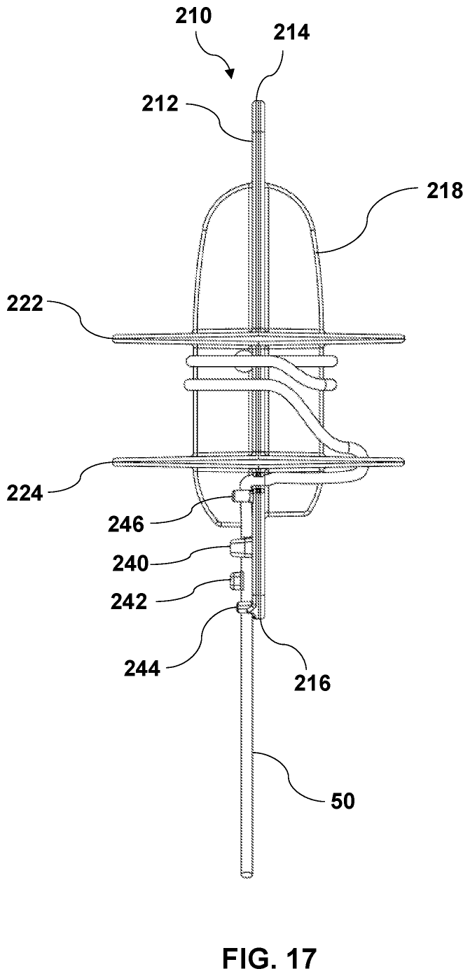

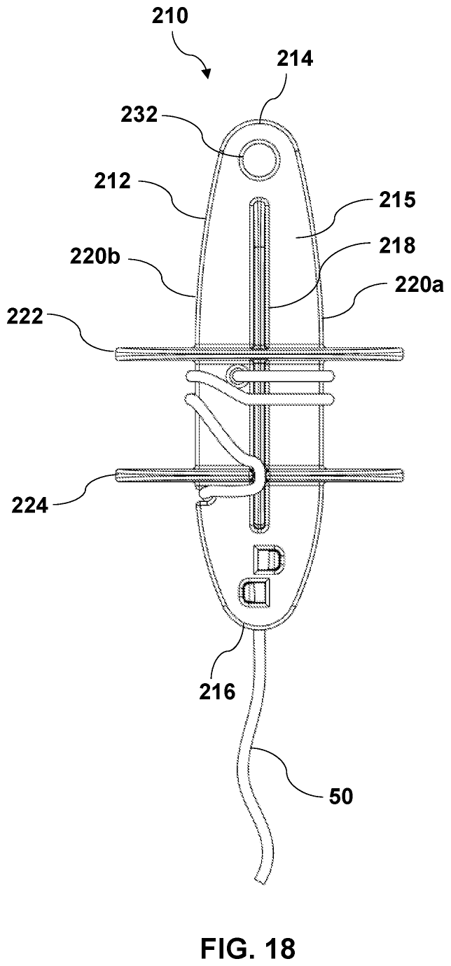

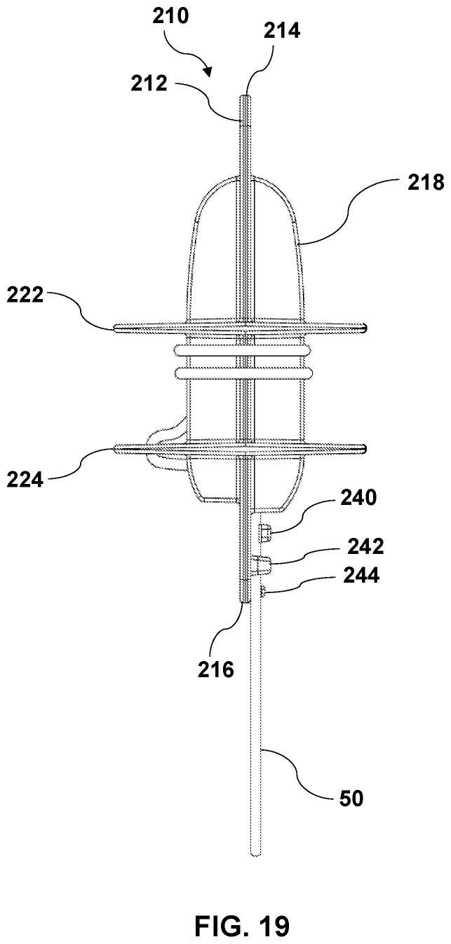

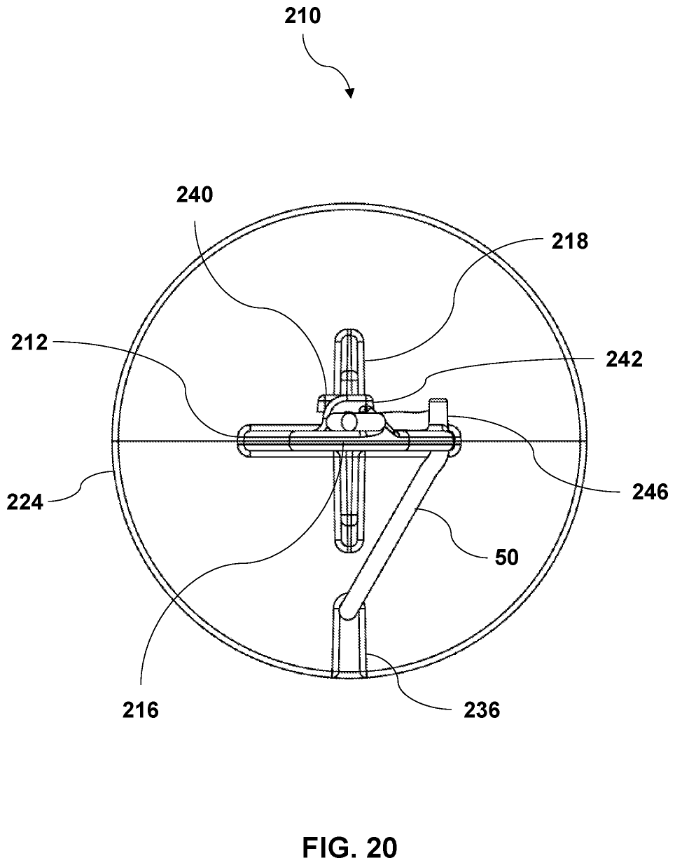

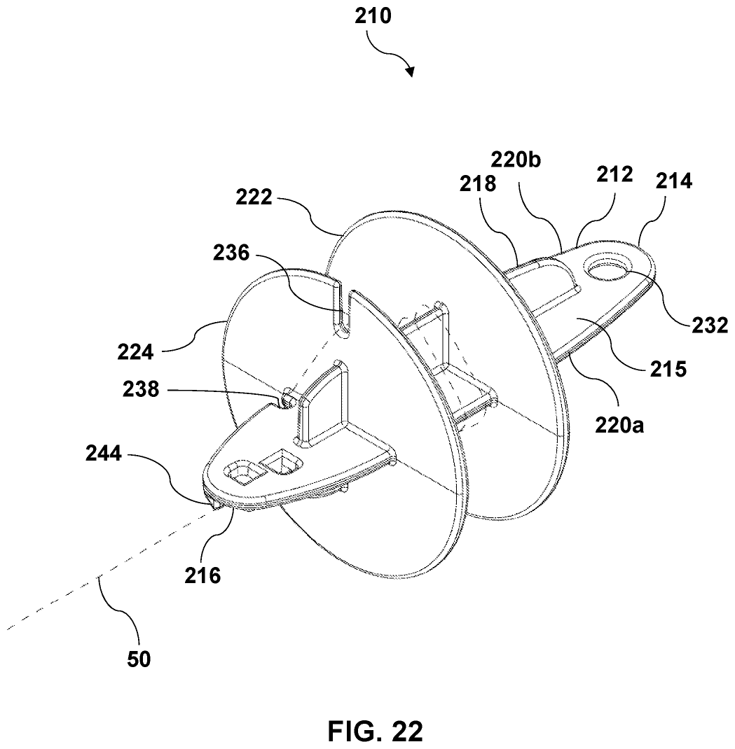

FIGS. 8-22 illustrate another embodiment of a decoy line adjuster 210. This embodiment is similar to decoy line adjuster 10. In decoy line adjuster 210, first hook 240 and second hook 242 are lined up parallel to each other. In some embodiments, first hook 240 and second hook 242 can generally be “J” shaped.

In some embodiments, decoy line adjuster 210 can be used to connect a floating hunting decoy to an anchor. For instance, in some embodiments, decoy line adjuster 210 can be used to connect a waterfowl decoy to an anchor. In some embodiments, decoy line adjuster 210 can adjust the length of line/cord 50 between decoy line adjuster 210 and the anchor. In some embodiments, decoy line adjuster 210 can be an adjusting spool. In some embodiments, line 50 can be a cord and the terms can be used interchangeably.

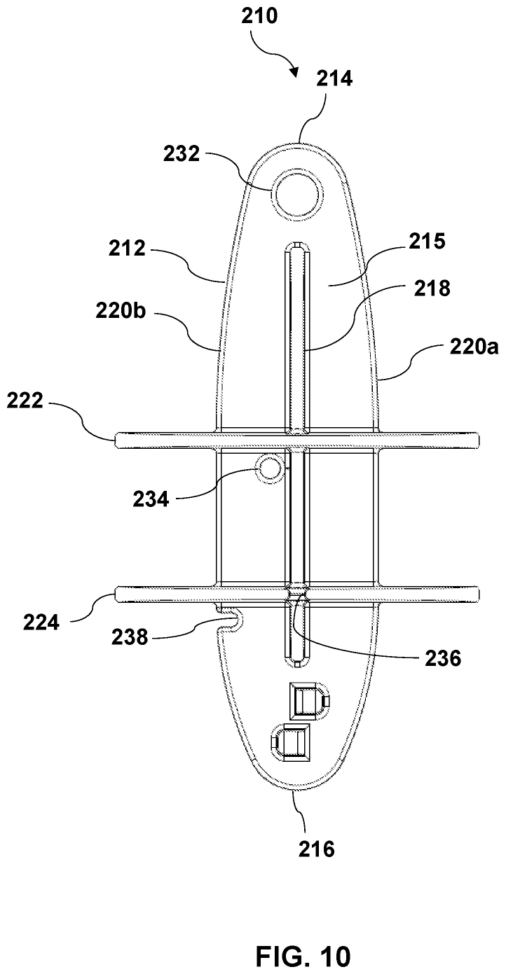

As shown in FIGS. 8-22, in some embodiments decoy line adjuster 210 can have body 212. Body 212 can include top end 214 and bottom end 216. In some embodiments, body 212 can also include opposed first face 213 and second face 215 (shown in FIGS. 10, 14-15, 18, and 22). In some embodiments, body 212 can be oblong. For example, in some embodiments, body 212 can have a generally oval shape. In some embodiments, body 212 can have a generally rectangular shape. The shape of body 212 can vary without departing from the scope of the disclosure.

In some embodiments, body 212 includes fin 218. In some embodiments, fin 218 protrudes perpendicularly from body 212. For example, in some embodiments, fin 218 protrudes perpendicularly from first face 213 and/or second face 215 of body 212. In some embodiments, fin 218 can be oblong. For example, in some embodiments, fin 18 can have a generally oval shape. In some embodiments, fin 218 can have a generally rectangular shape. The shape of fin 218 can vary without departing from the scope of the disclosure.

In some embodiments, fin 218 extends longitudinally, in a direction from top end 214 to bottom end 216 of body 212. For example, in some embodiments, fin 218 extends the length of body 212. In some embodiments, fin 218 partially extends the length of body 212. In some embodiments, fin 218 is shorter than the length of body 212. Furthermore, in some embodiments, fin 218 extends longitudinally through the center of body 212, dividing the body into first longitudinal half 220a and second longitudinal half 220b.

In some embodiments, body 212 includes at least one flange. In some embodiments, body 212 includes two flanges. In some embodiments, body 212 includes three flanges. In some embodiments, body 212 includes four flanges.

In some embodiments, body 212 includes first flange 222 and second flange 224. In some embodiments, first flange 222 and/or second flange 224 are parallel and spaced apart from one another. In some embodiments, first flange 222 and/or second flange 224 have a larger circumference than the circumference defined by body 212 and/or fin 218. In other words, in some embodiments, first flange 222 and/or second flange 224 extend beyond body 212 and fin 218. In some embodiments, first flange 222 and/or second flange 224 are perpendicular to body 212 and/or fin 218.

In some embodiments, fin 218, first flange 222, and/or second flange 224 can be attached to body 212. For example, fin 218, first flange 222, and/or second flange 224 can be attached via adhesion, welding, or other attachment methods. In some embodiments, body 212, fin 218, first flange 222, and/or second flange 224 can be manufactured as a singular, unitary piece. In some embodiments, first flange 222 and/or second flange 224 can be replaceable and/or can be swapped with other flanges with alternative properties, such as larger or smaller diameters.

In some embodiments, decoy line adjuster 210 can include decoy attaching portion 226, spool portion 228, and/or anchor attaching portion 230. For example, in some embodiments, decoy attaching portion 226 can include the portion extending from top end 214 to first flange 222. In some embodiments, spool portion 228 can include the portion extending from first flange 222 to second flange 224. In some embodiments, anchor attaching portion 230 can include the portion extending from second flange 224 to bottom end 216.

Turning to decoy attaching portion 226, decoy attaching portion 226 extends from top end 214 to first flange 222. In some embodiments, decoy attaching portion 226 can include aperture 232. In some embodiments, aperture 232 can be used to attach a decoy to the decoy line adjuster 210. For example, in some embodiments, decoy line adjuster 210 can be directly attached to a decoy via aperture 232. In some embodiments, one end of a line can be tied or otherwise attached to aperture 232 and the other end of the line can be tied or otherwise attached to a decoy.

In some embodiments, aperture 232 can be located on body 212. For example, in some embodiments, aperture 232 can be located near the top end 214. In this instance, fin 218 can be located below aperture 232 and extends towards the bottom end 216. In some embodiments, aperture 232 can be located on fin 218. The location of aperture 232 in decoy attaching portion 226 can vary without departing from the scope of the disclosure.

In some embodiments, spool portion 228 extends from first flange 222 to second flange 224. In some embodiments, spool portion 228 can be configured to resemble a spool and can be used to attach line 50 to decoy line adjuster 210 and/or to store excess line 50. In some embodiments, first flange 222 and second flange 224 can be spaced from one another, defining the ends of the spool. In at least some embodiments, the area between first flange 222 and second flange 224, including body 212 and fin 218, act as a barrel of a spool.

To attach line 50 to decoy line adjuster 210, in some embodiments, spool portion 228 can include spool aperture 234. For example, one end of line 50 can be tied or otherwise attached to the spool aperture 234. After line 50 is attached, a user can wrap line 50 around body 212 and fin 218 of spool portion 228 until a desired length of remaining line 50 is attained.

In some embodiments, spool aperture 234 can be located on body 212. For example, spool aperture 234 can be located in second longitudinal half 220b of body 212 near the intersection of fin 218 and first flange 222. In some embodiments, spool aperture 234 can be located on fin 218. The location of spool aperture 234 in the spool portion 228 can vary without departing from the scope of the disclosure.

In some embodiments, second flange 224 can include flange notch 236 in its perimeter, as shown in FIGS. 10-12, 14-15 and 20-22. In some embodiments, flange notch 236 extends towards second face 215 of body 212. For example, in some embodiments, flange notch 236 extends towards fin 218. In some embodiments, flange notch 236 is deep enough to receive line 50. For example, in some embodiments after attaching line 50 to spool portion 228 and the desired length of remaining line 50 is attained, line 50 can be passed through flange notch 236 and under second flange 224 to bring line 50 to anchor attaching portion 230.

In some embodiments, anchor attaching portion 230 extends from second flange 224 to bottom end 216. In some embodiments, the perimeter of anchor attaching portion 230 can include body notch 238 for receiving line 50 from spool portion 228. For example, in some embodiments, body notch 238 can be located near the top of anchor attaching portion 230, under second flange 224.

Additionally, in some embodiments, anchor attaching portion 230 includes a line locking system. In some embodiments, the locking system can be located on first face 213 of body 212. In some embodiments, the locking system includes at least one hook extending from body 212. In some embodiments, the locking system includes two hooks. In some embodiments, the locking system includes three hooks. In some embodiments, the locking system includes four hooks. In some embodiments, the locking system includes first hook 240 and second hook 242.

In some embodiments, first hook 240 and second hook 242 can have a first portion extending from body 212 that is substantially perpendicular with the plane of first face 213. Additionally, in at least some embodiments, first hook 240 and second hook 242 can have a second portion extending from the first portion, the second portion being substantially perpendicular with the first portion and parallel with the plane of first face 213.

In some embodiments, first hook 240 is located below fin 218. In some embodiments, the second portion of first hook 240 generally extends in a direction towards first longitudinal half 220a of body 212.

In some embodiments, second hook 242 is located below first hook 240 and is parallel to first hook 240. In some embodiments, the second portion of second hook 242 can extend towards second longitudinal half 220b of body 212. In at least some embodiments, the generally opposite orientations of hooks 240 and 242 allow for adjustable line 50 to be held in place by frictional forces. For example, after line 50 is run through body notch 238, first hook 240, and second hook 242, frictional forces between line 50 and body notch 238, line 50 and first hook 240, and/or line 50 and second hook 242 can keep line 50 in place.

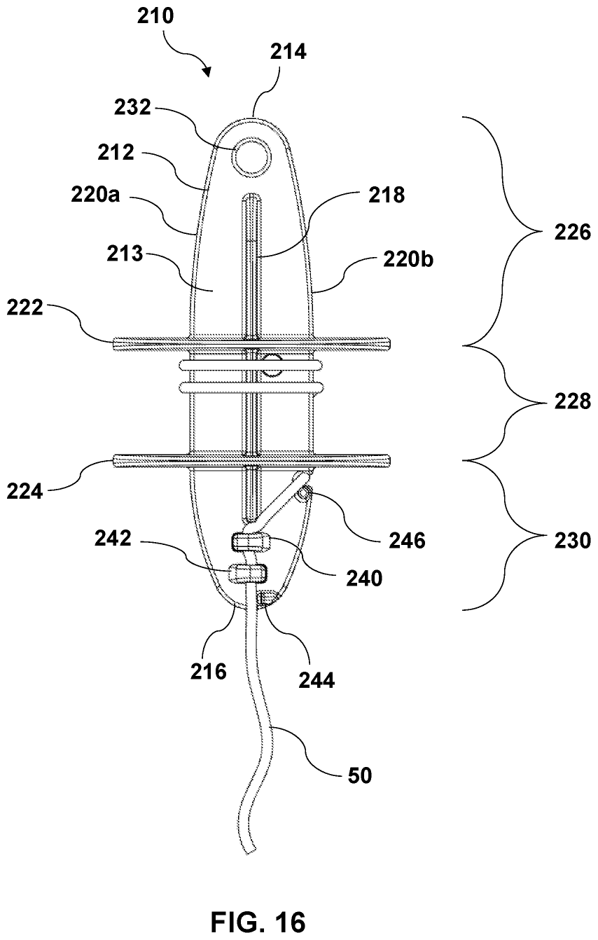

In some embodiments, line 50 can be further secured by guiding elements. For example, in some embodiments, locking system can also include a guide wall 244. Guide wall 244 can extend perpendicularly from first face 213 of body 212. In some embodiments, guide wall 244 can be located at bottom end 216 of body 212, below second hook 242. In some embodiments, guide wall 244 can extend longitudinally towards top end 214 of body 212. In some embodiments, guide wall 244 can keep adjustable line 50 from unhooking itself from second hook 242, can strengthen the frictional force between line 50 and second hook 242, and/or can add additional surface area on which a frictional force can act to keep line 50 in place. In some embodiments, the locking system can include guide rod 246 (as shown in FIGS. 8 and 16). Similar to guide wall 244, guide rod 246 can keep adjustable line 50 from unhooking itself from first hook 240, can strengthen the frictional force between line 50 and first hook 240, and/or can add additional surface area on which a frictional force can act to keep adjustable line 50 in place. In some embodiments, guide rod 246 can be located directly below body notch 238.

In some embodiments, the distance between the second portion of the hooks and body 212 can be smaller than the diameter of adjustable line 50. In some embodiments, the distance between the second portion of the hooks and body 212 can be slightly larger than the diameter of adjustable line 50. In some of these embodiments, after adjustable line 50 has been passed through the locking system, line 50 can be further secured by a squeezing force between the second portion of the hook and body 212. In some embodiments, the locking system can include apertures underneath the second portion of the hooks. In this instance, line 50 can be further secured by crimping caused by forces acting on line 50 from the hook and edges of the aperture. In some embodiments, the hooks can be made of a flexible material. In some of these embodiments, after passing line 50 through the locking system, the hooks can be crimped around line 50 to hold line 50 in place. In some embodiments, the locking system can include one or a combination of the features described herein.

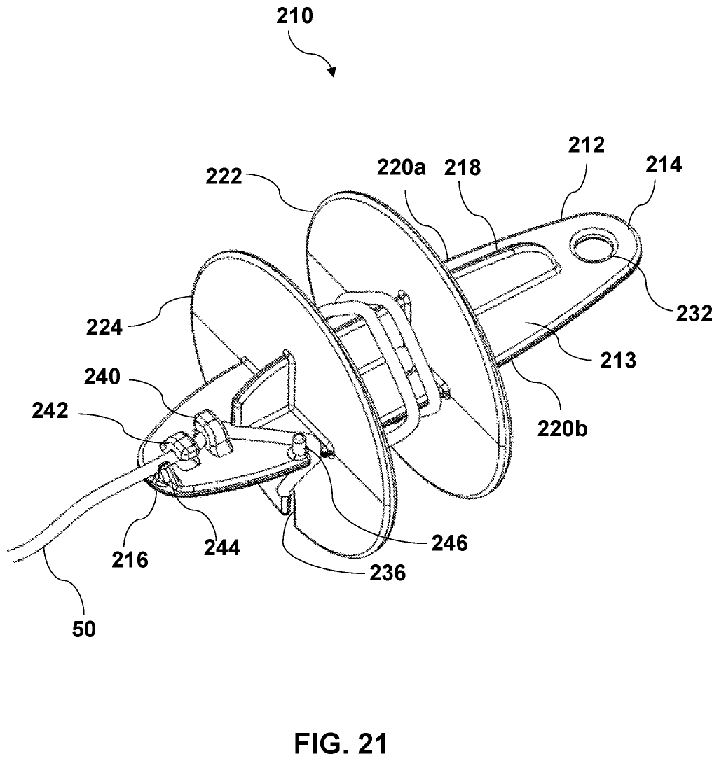

As shown in FIGS. 16-22, to use some embodiments of decoy line adjuster 210, adjustable line 50 can be attached to decoy line adjuster 210 via spool aperture 234. For example, in some embodiments, a user can pass line 50 through the spool aperture 234 to tie line 50 to decoy line adjuster 210. In some embodiments, line 50 can be passed through spool aperture 234 and a knot can then be tied in the portion of line 50 that passed through spool aperture 234, thus preventing, or at least reducing the chance that line 50 falls back through spool aperture 234. After attaching line 50 to decoy line adjuster 210, line 50 can be wrapped around spool portion 228 until a desired length of line 50 remains to be attached to an anchor. The remaining line 50 can be passed through flange notch 236 (shown in FIG. 21), then under second flange 224, and through body notch 238. Adjustable line 50 can then be hooked through the locking system by passing the line through first hook 240 and second hook 242. The end of line 50 can be attached to an anchor.

In some embodiments, to adjust the length of adjustable line 50, the user could unhook line 50 from second hook 242 and first hook 240, and then remove line 50 from body notch 238 and flange notch 236. If the user desires to shorten the length of line 50, the user can wrap the excess line 50 around spool portion 228 until the desired amount of line 50 remains. The user can then pass line 50 through the locking system as described above to secure line 50 in place. If the user desires to lengthen line 50, after removing line 50 from the locking system and notches 236 and 238, the user can unravel a desired length of line 50 from spool portion 228 until the desired length of line 50 is attained, and then pass line 50 through the locking system.

In some embodiments, at least some of the parts, if not all of the decoy line adjuster 210 can be made of a noncorrosive material, such as, but not limited to, one or more types of plastic. In some embodiments, decoy line adjuster 210 can be made of nylon.

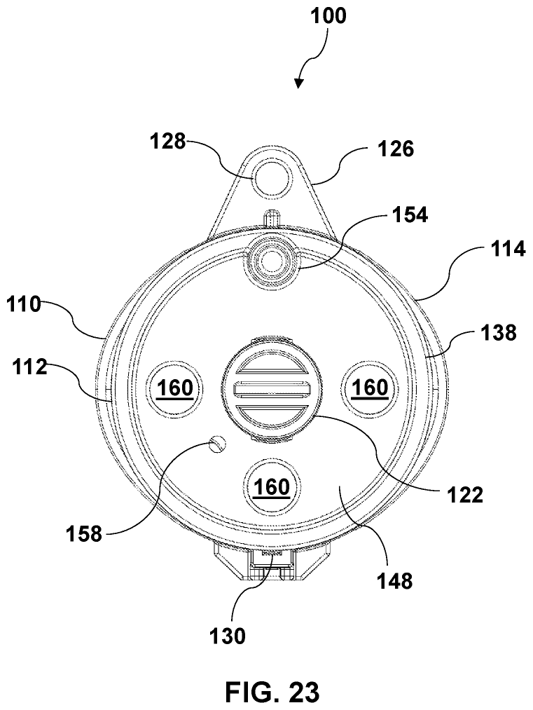

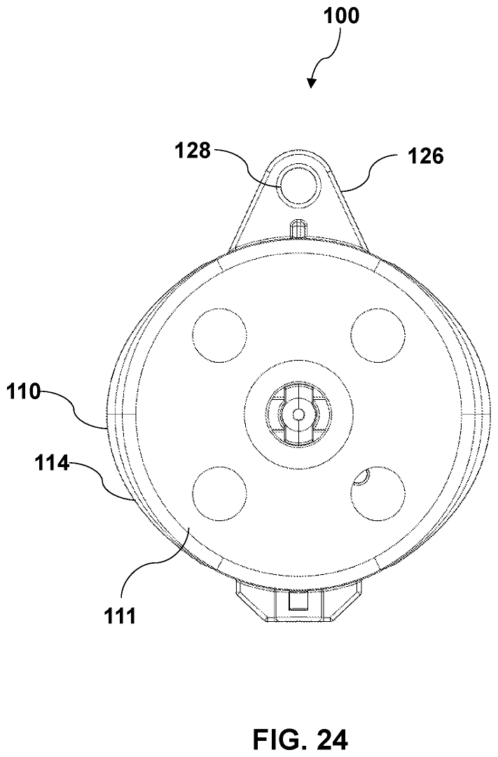

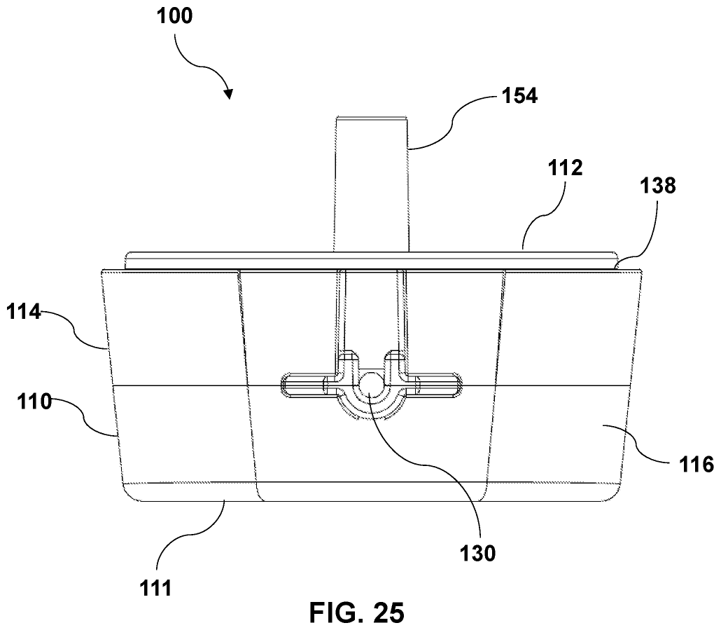

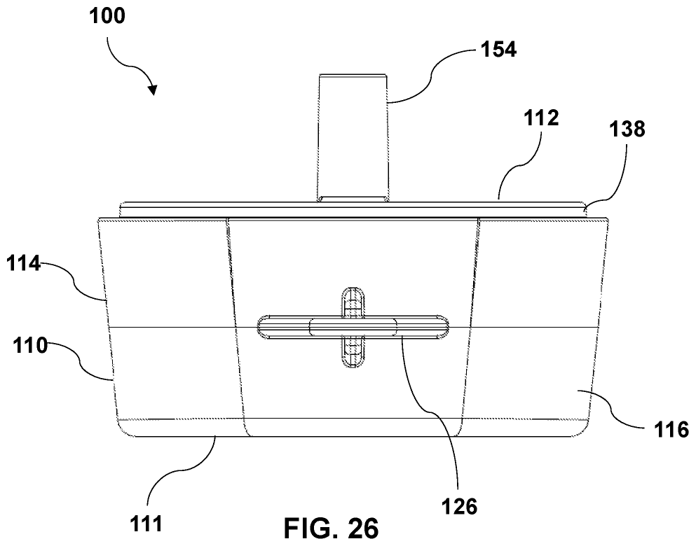

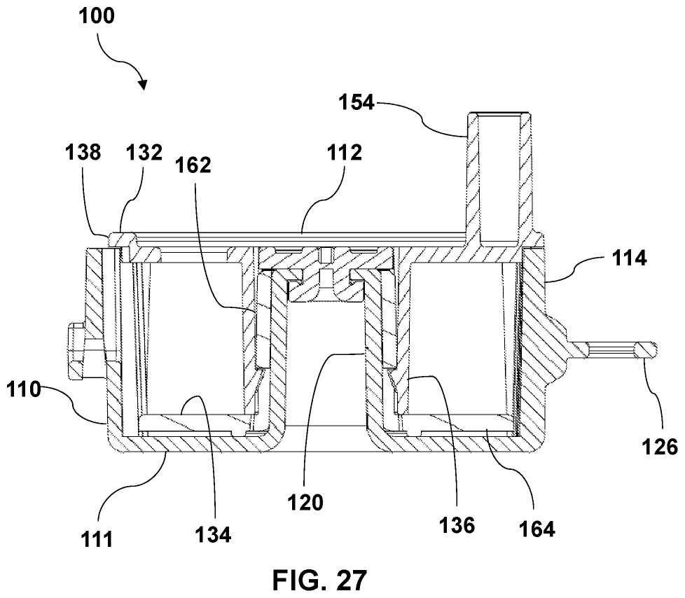

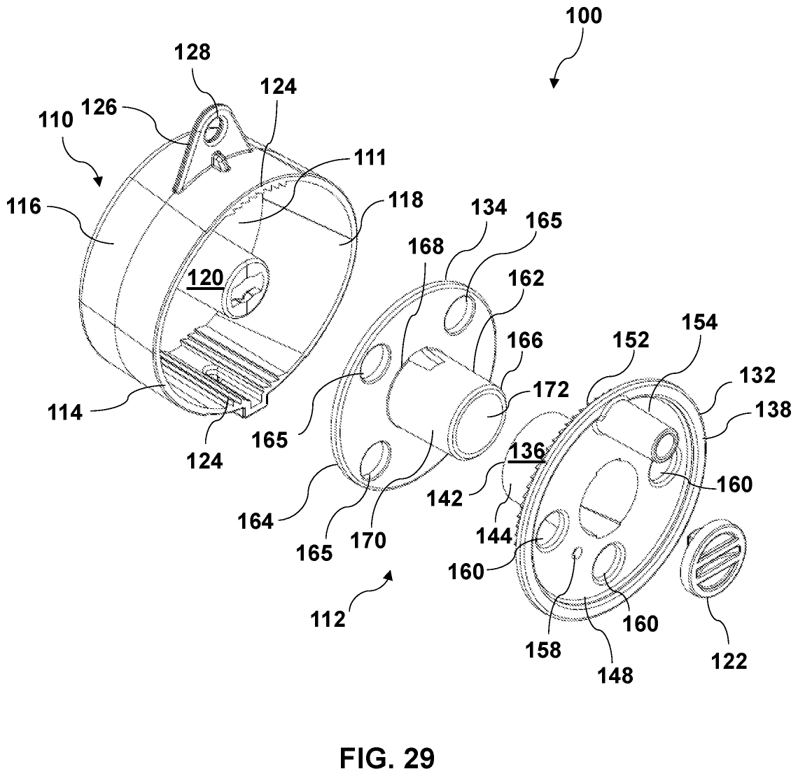

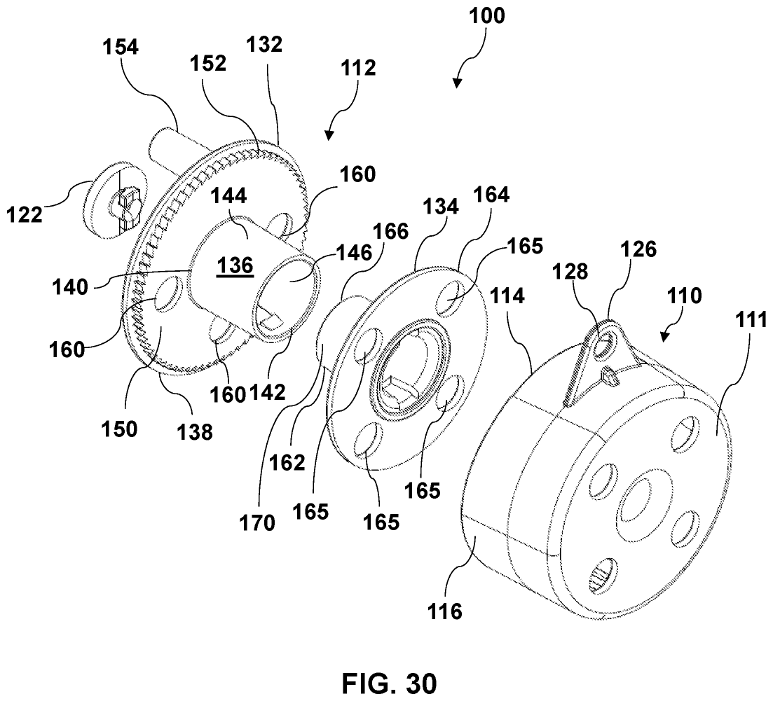

FIGS. 23-30 illustrate embodiments of decoy line adjuster 100. In some embodiments, decoy line adjuster 100 can be an adjusting reel.

In some embodiments, decoy line adjuster 100 can include shell 110 and spool 112. In some embodiments, shell 110 can include base 111 and wall 114. In some embodiments, base 111 is generally oval shaped. In some embodiments, wall 114 is located on the perimeter of base 111. In some embodiments, wall 114 includes wall outer surface 116 and wall inner surface 118. In some embodiments, base 111 and wall inner surface 118 define a cavity configured to receive spool 112.

In some embodiments, shell 110 includes axle 120. In some embodiments, axle 120 extends from the center of base 111. In some embodiments, axle 120 is configured to support spool 112. In some embodiments, after spool 112 is inserted into the cavity, retaining nut 122 can be attached to the tip of axle 120 to secure spool 112 within the cavity. For example, in some embodiments, retaining nut 122 can be attached to axle 120 via an interference fit. In some embodiments, retaining nut 122 can be attached to axle 120 using a screw-fit. In some embodiments, a twist lock mechanism can be recessed. Other methods of attaching retaining nut 122 to the tip of axle 120 can be used without departing from the scope of the disclosure.

In some embodiments, wall inner surface 118 can include cleats 124. In some embodiments, wall inner surface 118 can include three to four cleats 124. In some embodiments, wall inner surface 118 can include two sets of cleats 124 located across from one another on wall inner surface 118, wherein each set can include three to four cleats 124. In some embodiments, the entire wall inner surface 118 can include cleats 124. In some embodiments, cleats 124 can be configured to engage with teeth 152 located on spool 112.

In some embodiments, shell 110 can include tab 126. In some embodiments, tab 126 extends from wall outer surface 116. In some embodiments, tab 126 can include aperture 128. In some embodiments, aperture 128 can be used to attach a decoy to decoy line adjuster 100. For example, in some embodiments, decoy line adjuster 100 can be directly attached to the decoy via aperture 128. In some embodiments, one end of a line can be tied or otherwise attached to aperture 128 and the other end of the line can be tied or otherwise attached to a decoy.

In some embodiments, decoy line adjuster 100 can be connected to the decoy by other means, including but not limited to, a clevis hook or a swivel snap hook.

In some embodiments, shell 110 can include opening 130 in wall 114 located opposite tab 126. In some embodiments, the end of the line to be attached to an anchor can be passed through opening 130.

In some embodiments, spool 112 can include first piece 132 and second piece 134. In some embodiments, first piece 132 can include first barrel 136 and/or first flange 138. In some embodiments, first barrel 136 can include first end 140, second end 142, outer surface 144, and/or inner surface 146.

In some embodiments, inner surface 146 of first barrel 136 defines a lumen configured to receive the barrel of second piece 134. In some embodiments, first flange 138 can be located at first end 140 of barrel 136. In some embodiments, first flange 138 can have a generally circular shape.

In some embodiments, first flange 138 can include front face 148 and/or back face 150. In some embodiments, back face 150 can include teeth 152. In some embodiments, teeth 152 are located near the perimeter of first flange 138. In some embodiments, teeth 152 are configured to engage with cleats 124 of shell 110 to keep spool 112 from rotating without user intervention.

In some embodiments, front face 148 includes handle 154. For example, in some embodiments, handle 154 extends from front face 148. In some embodiments, handle 154 is attached to front face 148. For example, in some embodiments, handle 154 can be attached to first flange 138 via adhesive attachment, welding, or other attachment methods. In some embodiments, handle 154 is generally cylindrical. In some embodiments, handle 154 can be grasped by the user to rotate spool 112.

In some embodiments, first flange 138 can include flange aperture 158. In some embodiments, a line can be attached to decoy line adjuster 100 via flange aperture 158. For example, in some embodiments, the line can be passed through flange aperture 158 in a direction from back face 150 to front face 148. In some embodiments, a knot can then be tied in the portion of the line that passed through flange aperture 158, thus preventing the line from falling back through flange aperture 158.

In some embodiments, first flange 138 can include at least one window 160. In some embodiments, first flange 138 includes two windows 160. In some embodiments, first flange 138 includes three windows 160. In some embodiments, windows 160 enable a user to see how much line is wrapped around spool 112 when spool 112 is within shell 110. In some embodiments, first piece 132 can be made of a transparent material, enabling a user to see how much line is wrapped around spool 112 when it is within shell 110.

In some embodiments, second piece 134 can include second barrel 162 and/or second flange 164. In some embodiments, second barrel 162 can include first end 166, second end 168, outer surface 170, and/or inner surface 172. In some embodiments, inner surface 172 of second barrel 162 defines a lumen that is configured to receive axle 120 of shell 110. In some embodiments, second flange 164 can be located at second end 168 of second barrel 162. In some embodiments, second flange 164 can have a generally circular shape. In some embodiments, second flange 164 can include at least one window 165.

In some embodiments, first piece 132 and second piece 134 can be attached via a snap fit or screw fit. For example, in some embodiments, first barrel 136 and second barrel 162 can include corresponding snap-fit connections. For example, in some embodiments, first barrel 136 and second barrel 162 can have corresponding threads to be screwed to one another. In some embodiments, first barrel 136 can have at least one slot configured to receive at least one tab located on second barrel 162. In some embodiments, second barrel 162 can have at least one slot configured to receive at least one tab located on first barrel 136. Other detachable methods of attachment can be used without departing from the scope of the disclosure. In some embodiments, spool 112 can be formed by a single piece.

In some embodiments, to use decoy line adjuster 100, a line can be attached to spool 112 via flange aperture 158. In some embodiments, the line can be attached to first flange 138 either before or after attaching first piece 132 to second piece 134. In some embodiments, after attaching the line to flange aperture 158, the line can be wrapped around first barrel 136 of spool 112 until a desired length of line remains to be attached to an anchor. In some embodiments, the remaining line can be passed through opening 130 in shell 110. In some embodiments, spool 112 can then be placed within shell 110 and secured in place with retaining nut 122. In some embodiments, the loose end of the line can be attached to an anchor.

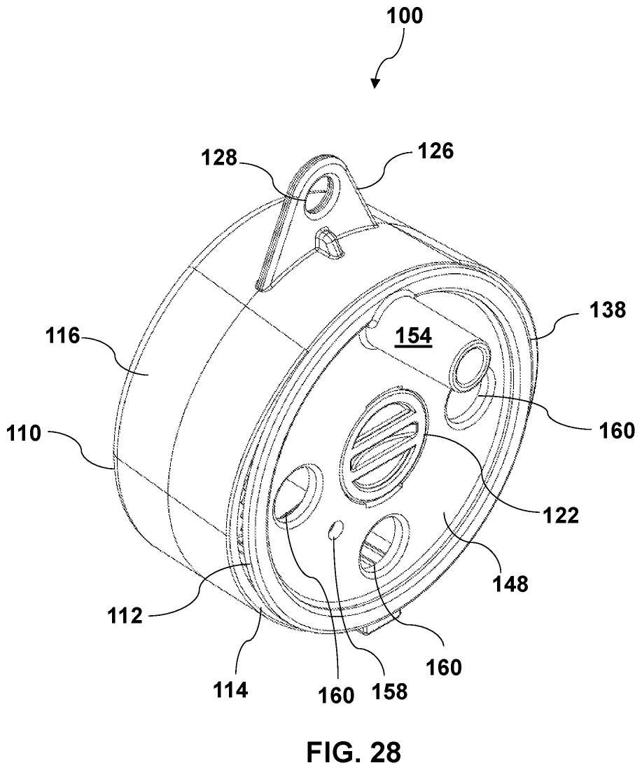

As shown in FIGS. 23 and 28, because shell 110 has a generally oval shape and first flange 138 has a generally circular shape in the embodiment shown, shell wall 114 bows beyond the perimeter of first flange 138. To adjust the length of the line, a user can squeeze shell wall 114 towards itself to release teeth 152 of spool 112 from cleats 124 of shell 110 and then, while squeezing, rotate spool 112 using handle 154. Depending on the direction the line was wrapped around spool 112, rotating spool 112 in one direction will shorten the line, and rotating spool 112 in the other direction will lengthen the line.

In some embodiments, to adjust the length of the line, a user can squeeze shell wall 114 towards itself to release teeth 152 of spool 112 from cleats 124 of shell 110 and then, while squeezing, the weight attached to the string can cause the string to automatically unspool.

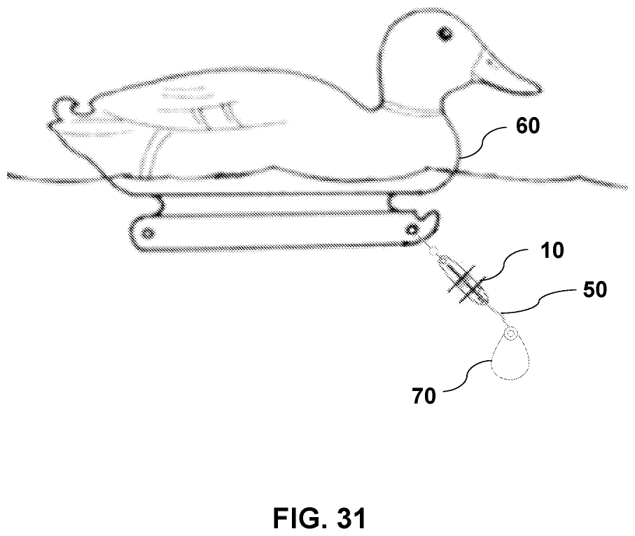

FIG. 31 is a schematic drawing of line decoy adjuster 10 being utilized with decoy 60 and weighted anchor 70. In some embodiments, other embodiments of line depth adjuster such as line depth adjuster 100 can be used. In some embodiments, other embodiments of line depth adjuster such as line depth adjuster 210 can be used. In some embodiments, line adjuster 10, line adjuster 210, and/or line adjuster 100 allow for decoys 60 with line(s) and weighted anchor 70 on them to be easily moved, transported, and/or adjusted without having to retie knots and/or remove line.

In some embodiments, at least some of the parts, if not all of the decoy line adjuster 100 can be made of a noncorrosive material, such as, but not limited to, one or more types of plastic. In some embodiments, decoy line adjuster 10 can be made of nylon.

In some embodiments, line adjuster 10, line adjuster 210, and/or line adjuster 100 can be made of a noncorrosive material.

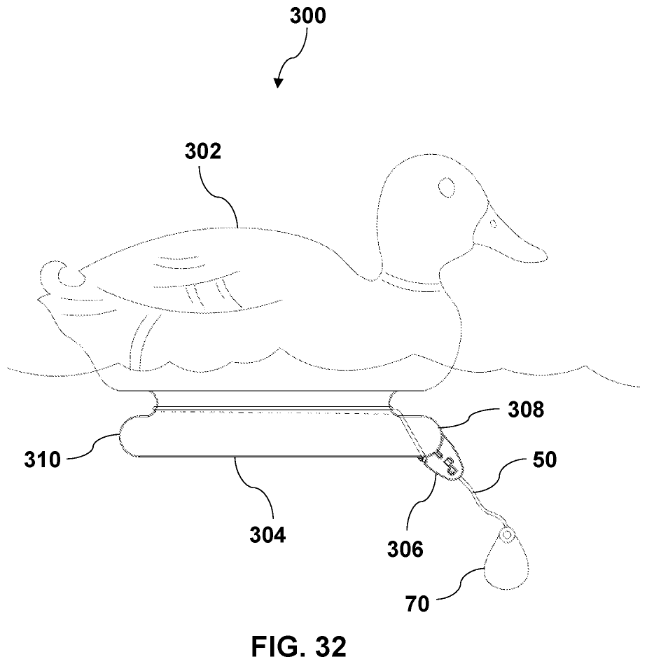

FIG. 32 is a schematic drawing of a line depth adjuster decoy 300. In some embodiments, decoy 300 includes a decoy portion 302, a keel 304, and a line depth adjuster 306. In some embodiments, line depth adjuster 306 is attached to keel 304. In some embodiments, line depth adjuster 306 is integrally attached to keel 304, such that decoy portion 302, keel 304, and line depth adjuster 306 are a unitary piece.

As shown in FIG. 32, in some embodiments, line depth adjuster 306 is attached to a front end 308 of keel 304. In some embodiments, line depth adjuster 306 can be attached to a back end 310 of keel 304. In some embodiments, the location of line depth adjuster 306 can vary on keel 304 without departing from the scope of the disclosure.

In some embodiments, line depth adjuster 306 can be similar to decoy line adjuster 10 and/or decoy line adjuster 210 as described herein. In some embodiments, line depth adjuster 306 can be similar to anchor attaching portion 30 of decoy line adjuster 10. In some embodiments, line depth adjuster 306 can be similar to anchor attaching portion 230 of decoy line adjuster 210.

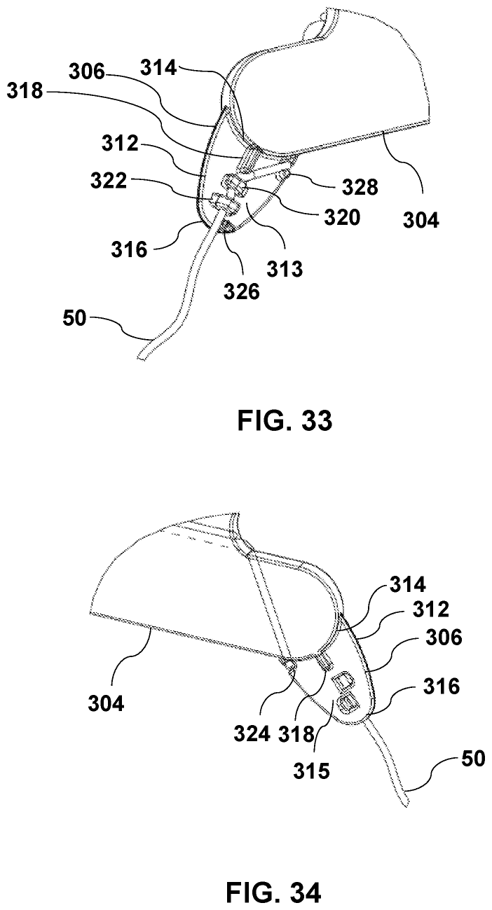

As shown in FIGS. 33-34, in some embodiments, line depth adjuster can be similar to anchor attaching portion 230 of line depth adjuster 210. In some embodiments, line depth adjuster 306 can have a body 312. Body 312 can extend from keel 304. Body 312 can include a first end 314 (located at keel 304) and second end 316. In some embodiments, body 312 extends from keel 304 at an angle. In some embodiments, body 312 can also include opposed first face 313 and second face 315 (shown in FIG. 34). In some embodiments, body 312 can be oblong. The shape of body 312 can vary without departing from the scope of the disclosure.

In some embodiments, body 312 includes fin 318. In some embodiments, fin 318 protrudes perpendicularly from body 312. For example, in some embodiments, fin 318 protrudes perpendicularly from first face 313 and/or second face 315 of body 312. In some embodiments, fin 18 extends longitudinally, in a direction from first end 314 towards second end 316 of body 312. For example, in some embodiments, fin 318 extends the length of body 312. In some embodiments, fin 318 partially extends the length of body 312. In some embodiments, fin 318 is shorter than the length of body 312. Furthermore, in some embodiments, fin 318 extends longitudinally through the center of body 12.

In some embodiments, the perimeter of body 312 can include body notch 324 for receiving line 50. For example, in some embodiments, body notch 324 can be located near the first end 314, under keel 304.

Additionally, in some embodiments, body 312 includes a line locking system. In some embodiments, the locking system can be located on first face 313 of body 312. In some embodiments, the locking system includes at least one hook extending from body 312. In some embodiments, the locking system includes two hooks. In some embodiments, the locking system includes three hooks. In some embodiments, the locking system includes four hooks.

In some embodiments, the locking system includes first hook 320 and second hook 322. In some embodiments, first hook 320 and second hook 322 can generally be “J” shaped.

In some embodiments, first hook 320 and second hook 322 can have a first portion extending from body 312 that is substantially perpendicular with the plane of first face 313. Additionally, in at least some embodiments, first hook 320 and second hook 322 can have a second portion extending from the first portion, the second portion being substantially perpendicular with the first portion and parallel with the plane of first face 313.

In some embodiments, first hook 320 is located below fin 318. In some embodiments, second hook 322 is located below first hook 320 and is parallel to first hook 320. In some embodiments, the second portion of first hook 320 generally extends in a first direction and the second portion of second hook 322 generally extends in an opposite direction in relation to second portion of first hook 320. In at least some embodiments, the generally opposite orientations of hooks 320 and 322 allow for adjustable line 50 to be held in place by frictional forces. For example, after line 50 is run through body notch 324 (shown in FIG. 33), first hook 320, and second hook 322, frictional forces between line 50 and body notch 324, line 50 and first hook 320, and/or line 50 and second hook 322 can keep line 50 in place.

In some embodiments, line 50 can be further secured by guiding elements. For example, in some embodiments, locking system can also include a guide wall 326. Guide wall 326 can extend perpendicularly from first face 313 of body 312. In some embodiments, guide wall 326 can be located at second end 316 of body 312, below second hook 322. In some embodiments, guide wall 326 can extend longitudinally towards first end 314 of body 312. In some embodiments, guide wall 326 can keep adjustable line 50 from unhooking itself from second hook 322, can strengthen the frictional force between line 50 and second hook 322, and/or can add additional surface area on which a frictional force can act to keep line 50 in place. In some embodiments, the locking system can include guide rod 328. Similar to guide wall 326, guide rod 328 can keep adjustable line 50 from unhooking itself from first hook 320, can strengthen the frictional force between line 50 and first hook 320, and/or can add additional surface area on which a frictional force can act to keep adjustable line 50 in place. In some embodiments, guide rod 328 can be located directly below body notch 324.

In some embodiments, the distance between the second portion of the hooks and body 312 can be smaller than the diameter of adjustable line 50. In some embodiments, the distance between the second portion of the hooks and body 312 can be slightly larger than the diameter of adjustable line 50. In some of these embodiments, after adjustable line 50 has been passed through the locking system, line 50 can be further secured by a squeezing force between the second portion of the hook and body 312. In some embodiments, the locking system can include apertures underneath the second portion of the hooks. In this instance, line 50 can be further secured by crimping caused by forces acting on line 50 from the hook and edges of the aperture. In some embodiments, the hooks can be made of a flexible material. In some of these embodiments, after passing line 50 through the locking system, the hooks can be crimped around line 50 to hold line 50 in place. In some embodiments, the locking system can include one or a combination of the features described herein.

In some embodiments, to use line depth adjuster decoy 300, a first end of line 50 is attached to keel 304. For instance, in some embodiments, line 50 can be tied to keel 304. In some embodiments, line 50 is wrapped around keel 304 until a desired length of line 50 remains to be attached to anchor 70. The remaining length of line 50 can be passed through the locking system of line depth adjuster 306. For instance, in some embodiments, the remaining line 50 can be passed through body notch 324 and then hooked through the locking system by passing the line through first hook 320 and second hook 322. The end of line 50 can be attached to anchor 70.

In some embodiments, to adjust the length of adjustable line 50, the user could unhook line 50 from second hook 322 and first hook 320, and then remove line 50 from body notch 324. If the user desires to shorten the length of line 50, the user can wrap the excess line 50 around keel 304 until the desired amount of line 50 remains. The user can then pass line 50 through the locking system as described above to secure line 50 in place. If the user desires to lengthen line 50, after removing line 50 from the locking system and notch 324, the user can unravel a desired length of line 50 from keel 304 until the desired length of line 50 is attained, and then pass line 50 through the locking system.

In some embodiments, at least some of the parts, if not all of line depth adjuster 306 can be made of a noncorrosive material, such as, but not limited to, one or more types of plastic. In some embodiments, line depth adjuster 306 can be made of nylon.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present invention have been shown and described, it will be understood, that the invention is not limited thereto since modifications can be made without departing from the scope of the present disclosure, particularly in light of the foregoing teachings.

What is claimed:

1. A decoy line adjuster comprising:
a line; and
a body comprising:
a top end;
a bottom end;
a fin;
a first flange; and
a second flange.

2. The decoy line adjuster of claim 1 wherein said second flange includes a flange notch configured to receive said line.

3. The decoy line adjuster of claim 1 wherein said body is divided into a decoy attaching potion; a spool potion; and an anchoring attaching potion.

4. The decoy line adjuster of claim 3 wherein said decoy attaching potion comprises an aperture.

5. The decoy line adjuster of claim 3 wherein said anchoring attaching potion comprises
a body notch configured to receive said line; and
a line locking system.

6. The decoy line adjuster of claim 5 wherein said line locking system comprises:
a first hook and
a second hook.

7. The decoy line adjuster of claim 6 wherein said line locking system further comprises:
a guide wall.

8. The decoy line adjuster of claim 6 wherein said line locking system further comprises:
a guide rod.

9. The decoy line adjuster of claim 6 wherein said first hook and said second hook have generally opposite orientations.

10. The decoy line adjuster of claim 1 wherein said fin protrudes perpendicularly from said body.

11. The decoy line adjuster of claim 1 wherein said fin extends longitudinally from said top end to said bottom end along a length of said body.

12. The decoy line adjuster of claim 1 wherein said first flange is parallel to said second flange.

13. The decoy line adjuster of claim 1 wherein said first flange is perpendicular to said fin.

14. A decoy line adjuster comprising:
a line;
a spool; and
a shell comprising:
an oval base;
a wall extending up from said oval base;
an axle; and
a tab with an aperture.

15. The decoy line adjuster of claim 14 wherein said decoy line adjuster is attached to a decoy.

16. The decoy line adjuster of claim 15 wherein said axle is configured to support said spool.

17. The decoy line adjuster of claim 15 wherein said spool has a plurality of teeth configured to interact with a plurality of cleats located on said wall.

18. The decoy line adjuster of claim 17 wherein said shell is oval.

19. A system comprising:
a decoy line adjuster;
a decoy;
a weight; and
a line.

20. The system of claim 19, wherein said decoy line adjuster comprises:
a line; and
a body comprising:
a top end;
a bottom end;
a fin;
a first flange; and
a second flange.
